(19) United States
(12) Patent Application Publication
(10) Pub. No.: US 2023/0308909 A1
(43) Pub. Date: Sep. 28, 2023

(54) METHOD AND APPARATUS FOR RECOVERING FROM BEAM FAILURE ON BASIS OF SIDELINK IN WIRELESS COMMUNICATION SYSTEM

(71) Applicant: LG ELECTRONICS INC., Seoul (KR)

(72) Inventor: Byounggill KIM, Seoul (KR)

(21) Appl. No.: 18/015,673

(22) PCT Filed: Jul. 15, 2021
(86) PCT No.: PCT/KR2021/009130

§ 371 Date: Jan. 11, 2023

(30) Foreign Application Priority Data
Aug. 13, 2020 (KR) 10-2020-0101957

(51) Int. Cl. H04W 24/04; H04B 7/06

(52) U.S. Cl. CPC H04W 24/04; H04B 7/0695

(57) ABSTRACT

In order to recover a beam failure based on sidelink in a wireless communication system, a method of operating a first terminal comprises performing communication with a second terminal using a first beam, transmitting a request signal including information related to a second beam to replace the first beam as a beam failure of the first beam is detected, receiving a response signal corresponding to the request signal from the second terminal, and performing communication with the second terminal using the second beam. The request signal may be transmitted through a resource associated with the second beam among resources related to discovery

### CROSS REFERENCE TO RELATED APPLICATIONS

This application is a National Stage under 35 U.S.C. 371 of International Application No. PCT/KR2021/009130, filed on Jul. 15, 2021, which claims the benefit of Korean Patent Application No. 10-2020-0101957, filed on Aug. 13, 2020, the contents of which are all hereby incorporated by reference herein in their entirety.

### TECHNICAL FIELD

The following description relates to a wireless communication system, and, more particularly, to a method and apparatus for recovering a beam failure based on sidelink in a wireless communication system.

### BACKGROUND

A wireless communication system is a multiple access system that supports communication of multiple users by sharing available system resources (e.g., a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (mMTC), Ultra-Reliable and Low Latency Communication (URLLC), and so on, may be referred to as a new radio access technology (RAT) or new radio (NR). Herein, the NR may also support vehicle-to-everything (V2X) communication.

### SUMMARY

The present disclosure relates to a method and apparatus for effectively performing a beam failure recovery procedure based on sidelink in a wireless communication system.

The present disclosure relates to a method and apparatus for performing a beam failure recovery procedure using a sidelink discovery resource in a wireless communication system.

The technical objects to be achieved in the present disclosure are not limited to the above-mentioned technical objects, and other technical objects that are not mentioned may be considered by those skilled in the art through the embodiments described below.

As an example of the present disclosure, a method of operating a first terminal in a wireless communication system may comprise performing communication with a second terminal using a first beam, transmitting a request signal including information related to a second beam to replace the first beam as a beam failure of the first beam is detected, receiving a response signal corresponding to the request signal from the second terminal, and performing communication with the second terminal using the second beam. The request signal may be transmitted through a resource associated with the second beam among resources related to discovery.

As an example of the present disclosure, a method of operating a second terminal in a wireless communication system may comprise performing communication with a first terminal using a first beam, receiving a request signal including information related to a second beam to replace the first beam as a beam failure of the first beam is detected, transmitting a response signal corresponding to the request signal to the second terminal, and performing communication with the second terminal using the second beam. The request signal may be transmitted through a resource associated with the second beam among resources related to discovery.

As an example of the present disclosure, a first terminal in a wireless communication system may comprise a transceiver and a processor coupled to the transceiver. The processor may transmit a request signal including information related to a second beam to replace a first beam as a beam failure of the first beam is detected, receive a response signal corresponding to the request signal from a second terminal and perform communication with the second terminal using the second beam. The request signal may be transmitted through a resource associated with the second beam among resources related to discovery.

As an example of the present disclosure, a second terminal in a wireless communication system may comprise a transceiver and a processor coupled to the transceiver. The processor may perform communication with a first terminal using a first beam, receive a request signal including information related to a second beam to replace the first beam as a beam failure of the first beam is detected, transmit a response signal corresponding to the request signal to the second terminal and perform communication with the second terminal using the second beam. The request signal may be transmitted through a resource associated with the second beam among resources related to discovery.

As an example of the present disclosure, an apparatus may comprise at least one processor and at least one computer memory connected to the at least one processor and configured to store instructions indicating operations as executed by the at least one processor. The operations may control the apparatus to transmit a request signal including information related to a second beam to replace a first beam as a beam failure of the first beam is detected, to receive a response signal corresponding to the request signal from another apparatus and to perform communication with the another apparatus using the second beam. The request signal may be transmitted through a resource associated with the second beam among resources related to discovery.

As an example of the present disclosure, a non-transitory computer-readable medium storing at least one instruction may comprise the at least one instruction executable by a processor. The at least one instruction may control an apparatus to perform communication with a second terminal using a first beam, to transmit a request signal including information related to a second beam to replace the first beam as a beam failure of the first beam is detected, to receive a response signal corresponding to the request signal from another apparatus and to perform communication with the another apparatus using the second beam. The request signal may be transmitted through a resource associated with the second beam among resources related to discovery.

The above-described aspects of the present disclosure are merely some of the preferred embodiments of the present disclosure, and various embodiments reflecting the technical features of the present disclosure may be derived and understood by those of ordinary skill in the art based on the following detailed description of the disclosure.

As is apparent from the above description, the embodiments of the present disclosure have the following effects.

According to the present disclosure, a beam failure situation during sidelink communication can be effectively recovered.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates a structure of a wireless communication system, applicable to an embodiment of the present disclosure.

FIG. 2 illustrates a functional division between an NG-RAN and a SGC, applicable to an embodiment of the present disclosure.

FIG. 3A and FIG. 3B illustrate a radio protocol architecture, applicable to an embodiment of the present disclosure.

FIG. 4 illustrates a structure of a radio frame in an NR system, applicable to an embodiment of the present disclosure.

FIG. 5 illustrates a structure of a slot in an NR frame, applicable to an embodiment of the present disclosure.

FIG. 6 illustrates an example of a BWP, applicable to an embodiment of the present disclosure.

FIGS. 7A and 7B illustrate a radio protocol architecture for a SL communication, applicable to an embodiment of the present disclosure.

FIG. 8 illustrates a synchronization source or synchronization reference of V2X, applicable to an embodiment of the present disclosure.

FIGS. 9A and 9B illustrate a procedure of performing V2X or SL communication by a terminal based on a transmission mode, applicable to an embodiment of the present disclosure.

FIGS. 10A to 10C illustrate three cast types, applicable to an embodiment of the present disclosure.

FIG. 11 illustrates a concept of relay communication based on sidelink in a wireless communication system according to an embodiment of the present disclosure.

FIG. 12 illustrates an example of a method performed by a terminal requesting relay communication in a wireless communication system according to an embodiment of the present disclosure.

FIG. 13 illustrates an example of a method performed by a terminal participating in relay communication in a wireless communication system according to an embodiment of the present disclosure.

FIG. 14 illustrates an example of a method performed by a relay apparatus in a wireless communication system according to an embodiment of the present disclosure.

FIG. 15 illustrates an example of a scenario in which relay communication is performed by intersection rotation in a wireless communication system according to an embodiment of the present disclosure.

FIG. 16 illustrates an example of a procedure for relay communication by intersection rotation in a wireless communication system according to an embodiment of the present disclosure.

FIG. 17 illustrates an example of a scenario in which relay communication is performed by intervening another vehicle in a wireless communication system according to an embodiment of the present disclosure.

FIG. 18 illustrates an example of a scenario in which relay communication is terminated in a wireless communication system according to an embodiment of the present disclosure.

FIG. 19 illustrates another example of a beam failure recovery procedure in a wireless communication system according to an embodiment of the present disclosure.

FIG. 20 illustrates a communication system, applicable to an embodiment of the present disclosure.

FIG. 21 illustrates wireless devices, applicable to an embodiment of the present disclosure.

FIG. 22 illustrates a signal process circuit for a transmission signal, applicable to an embodiment of the present disclosure.

FIG. 23 illustrates a wireless device, applicable to an embodiment of the present disclosure.

FIG. 24 illustrates a hand-held device, applicable to an embodiment of the present disclosure.

FIG. 25 illustrates a car or an autonomous vehicle, applicable to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDDCH” may be proposed as an example of the “control information”. In addition, when indicated as “control information (i.e., PDCCH)”, it may also mean that “PDCCH” is proposed as an example of the “control information”.

In the following description, ‘when, if, or in case of may be replaced with ‘based on’.

A technical feature described individually in one figure in the present specification may be individually implemented, or may be simultaneously implemented.

In the present disclosure, a higher layer parameter may be a parameter which is configured, pre-configured or pre-defined for a UE. For example, a base station or a network may transmit the higher layer parameter to the UE. For example, the higher layer parameter may be transmitted through radio resource control (RRC) signaling or medium access control (MAC) signaling.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16 m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

For terms and techniques not specifically described among terms and techniques used in the present disclosure, reference may be made to a wireless communication standard document published before the present disclosure is filed. For example, the following document may be referred to.
(1) 3GPP LTE
   3GPP TS 36.211: Physical channels and modulation
   3GPP TS 36.212: Multiplexing and channel coding
   3GPP TS 36.213: Physical layer procedures
   3GPP TS 36.214: Physical layer; Measurements
   3GPP TS 36.300: Overall description
   3GPP TS 36.304: User Equipment (UE) procedures in idle mode
   3GPP TS 36.314: Layer 2 - Measurements
   3GPP TS 36.321: Medium Access Control (MAC) protocol
   3GPP TS 36.322: Radio Link Control (RLC) protocol
   3GPP TS 36.323: Packet Data Convergence Protocol (PDCP)
   3GPP TS 36.331: Radio Resource Control (RRC) protocol
(2) 3GPP NR (e.g. 5G)
   3GPP TS 38.211: Physical channels and modulation
   3GPP TS 38.212: Multiplexing and channel coding
   3GPP TS 38.213: Physical layer procedures for control
   3GPP TS 38.214: Physical layer procedures for data
   3GPP TS 38.215: Physical layer measurements
   3GPP TS 38.300: Overall description
   3GPP TS 38.304: User Equipment (UE) procedures in idle mode and in RRC inactive state
   3GPP TS 38.321: Medium Access Control (MAC) protocol
   3GPP TS 38.322: Radio Link Control (RLC) protocol
   3GPP TS 38.323: Packet Data Convergence Protocol (PDCP)
   3GPP TS 38.331: Radio Resource Control (RRC) protocol
   3GPP TS 37.324: Service Data Adaptation Protocol (SDAP)
   3GPP TS 37.340: Multi-connectivity; Overall description

### Communication System Applicable to the Present Disclosure

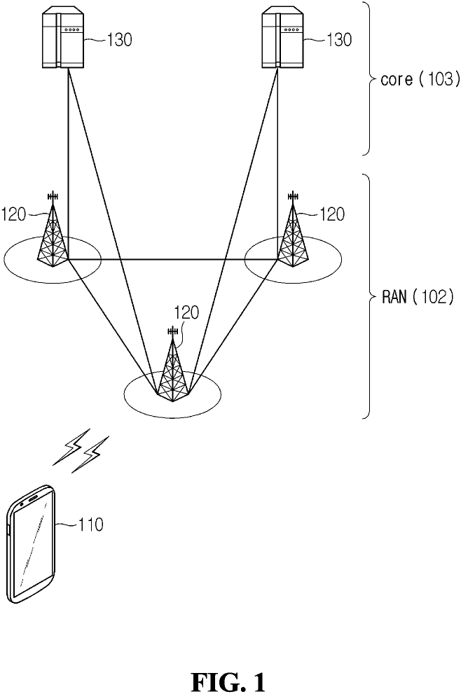

FIG. 1 illustrates a structure of a wireless communication system applicable to the present disclosure. The embodiment of FIG. 1 may be combined with various embodiments of the present disclosure.

Referring to FIG. 1, a wireless communication system includes a radio access network (RAN) 102 and a core network 103. The radio access network 102 includes a base station 120 that provides a control plane and a user plane to a terminal 110. The terminal 110 may be fixed or mobile, and may be called other terms such as a user equipment (UE), a mobile station (MS), a subscriber station (SS), a mobile subscriber station (MSS), a mobile terminal, an advanced mobile station (AMS), or a wireless device. The base station 120 refers to a node that provides a radio access service to the terminal 110, and may be called other terms such as a fixed station, a Node B, an eNB (eNode B), a gNB (gNode B), an ng-eNB, an advanced base station (ABS), an access point, a base transceiver system (BTS), or an access point (AP). The core network 103 includes a core network entity 130. The core network entity 130 may be defined in various ways according to functions, and may be called other terms such as a core network node, a network node, or a network equipment.

Components of a system may be referred to differently according to an applied system standard. In the case of the LTE or LTE-A standard, the radio access network 102 may be referred to as an Evolved-UMTS Terrestrial Radio Access Network (E-UTRAN), and the core network 103 may be referred to as an evolved packet core (EPC). In this case, the core network 103 includes a Mobility Management Entity (MME), a Serving Gateway (S-GW), and a packet data network-gateway (P-GW). The MME has access information of the terminal or information on the capability of the terminal, and this information is mainly used for mobility management of the terminal. The S-GW is a gateway having an E-UTRAN as an endpoint, and the P-GW is a gateway having a packet data network (PDN) as an endpoint.

In the case of the 5G NR standard, the radio access network 102 may be referred to as an NG-RAN, and the core network 103 may be referred to as a 5GC (5G core). In this case, the core network 103 includes an access and mobility management function (AMF), a user plane function (UPF), and a session management function (SMF). The AMF provides a function for access and mobility management in units of terminals, the UPF performs a function of mutually transmitting data units between an upper data network and the radio access network 102, and the SMF provides a session management function.

The BSs 120 may be connected to one another via Xn interface. The BS 120 may be connected to one another via core network 103 and NG interface. More specifically, the BSs 130 may be connected to an access and mobility management function (AMF) via NG-C interface, and may be connected to a user plane function (UPF) via NG-U interface.

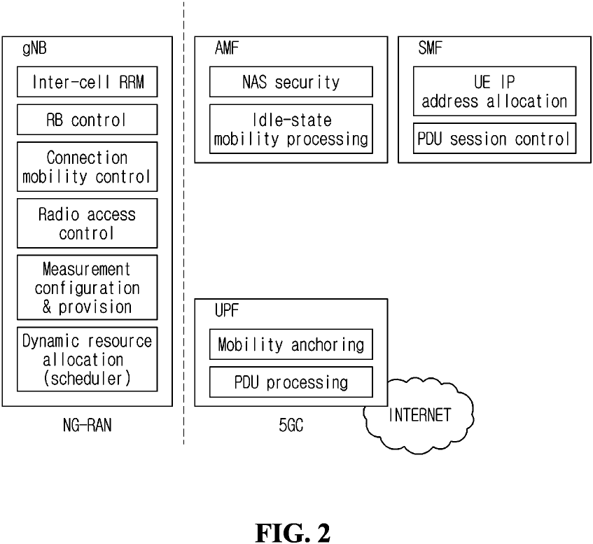

FIG. 2 illustrates a functional division between an NG-RAN and a 5GC, applicable to the present disclosure. The embodiment of FIG. 2 may be combined with various embodiments of the present disclosure.

Referring to FIG. 2, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (layer 1, L1), a second layer (layer 2, L2), and a third layer (layer 3, L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer enable to exchange an RRC message between the UE and the BS.

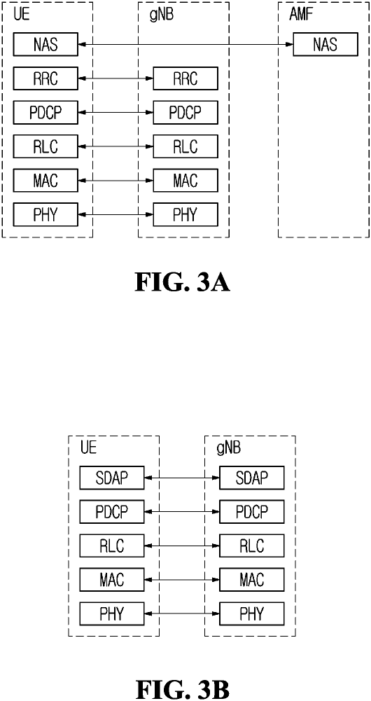

FIGS. 3A and 3B illustrate a radio protocol architecture, applicable to the present disclosure. The embodiment of FIGS. 3 may be combined with various embodiments of the present disclosure. Specifically, FIG. 3A exemplifies a radio protocol architecture for a user plane, and FIG. 3B exemplifies a radio protocol architecture for a control plane. The user plane corresponds to a protocol stack for user data transmission, and the control plane corresponds to a protocol stack for control signal transmission.

Referring to FIGS. 3A and 3B, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PI-TY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

### Radio Resource Structure

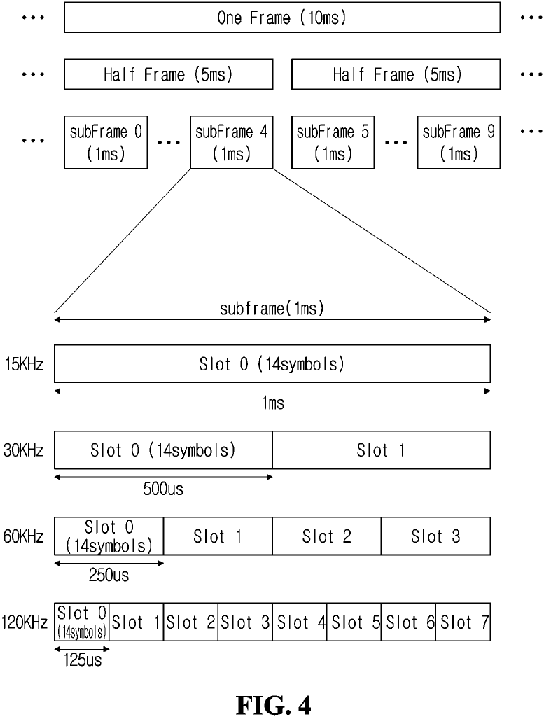

FIG. 4 illustrates a structure of a radio frame in an NR system, applicable to the present disclosure. The embodiment of FIG. 4 may be combined with various embodiments of the present disclosure.

Referring to FIG. 4, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

In a case where a normal CP is used, a number of symbols per slot (N^{slot}_{symb}), a number slots per frame (N^{frame,µ}ₛₗₒₜ), and a number of slots per subframe (N^{subframe,µ}ₛₗₒₜ) may be varied based on an SCS configuration (µ). For instance, SCS (=15*2^{µ}), N^{slot}_{symb}, N^{frame,µ}ₛₗₒₜ and N^{subframe,u}ₛₗₒₜ are 15 KHz, 14, 10 and 1, respectively, when µ=0, are 30 KHz, 14, 20 and 2, respectively, when µ=1, are 60 KHz, 14, 40 and 4, respectively, when µ=2, are 120 KHz, 14, 80 and 8, respectively, when µ=3, or are 240 KHz, 14, 160 and 16, respectively, when µ=4. Meanwhile, in a case where an extended CP is used, SCS (=15*2^{µ}), N^{slot}_{symb}, N^{frame,µ} and N^{subframe,µ} are 60 KHz, 12, 40 and 2, respectively, when µ=2.

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells.

In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, frequency ranges corresponding to the FR1 and FR2 may be 450 MHz-6000 MHz and 24250 MHz-52600 MHz, respectively. Further, supportable SCSs is 15, 30 and 60 kHz for the FR1 and 60, 120, 240 kHz for the FR2. Among the frequency ranges that are used in an NR system, FR1 may mean a “sub 6 GHz range”, and FR2 may mean an “above 6 GHz range” and may also be referred to as a millimeter wave (mmW).

As described above, the values of the frequency ranges in the NR system may be changed (or varied). For example, comparing to examples for the frequency ranges described above, FR1 may be defined to include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

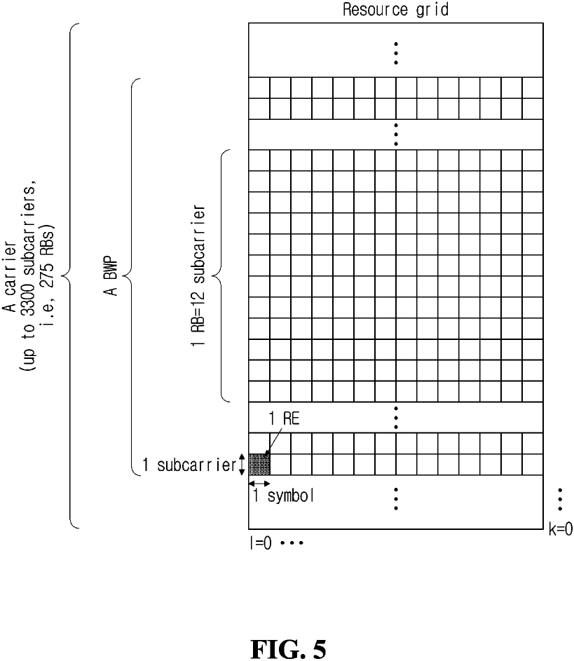

FIG. 5 illustrates a structure of a slot of an NR frame, applicable to the present disclosure. The embodiment of FIG. 5 may be combined with various embodiments of the present disclosure.

Referring to FIG. 5, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

### Bandwidth Part (BWP)

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, PDSCH, or CSI-RS (excluding RRM) outside the active DL BWP. For example, the UE may not trigger a channel state information (CSI) report for the inactive DL BWP. For example, the UE may not transmit a Physical Uplink Control Channel (PUCCH) or a Physical Uplink Shared Channel (PUSCH) outside an active UL BWP. For example, in a downlink case, the initial BWP may be given as a consecutive RB set for a remaining minimum system information (RMSI) control resource set (CORESET) (configured by PBCH). For example, in an uplink case, the initial BWP may be given by system information block (SIB) for a random access procedure. For example, the default BWP may be configured by a higher layer. For example, an initial value of the default BWP may be an initial DL BWP. For energy saving, if the UE fails to detect downlink control information (DCI) during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

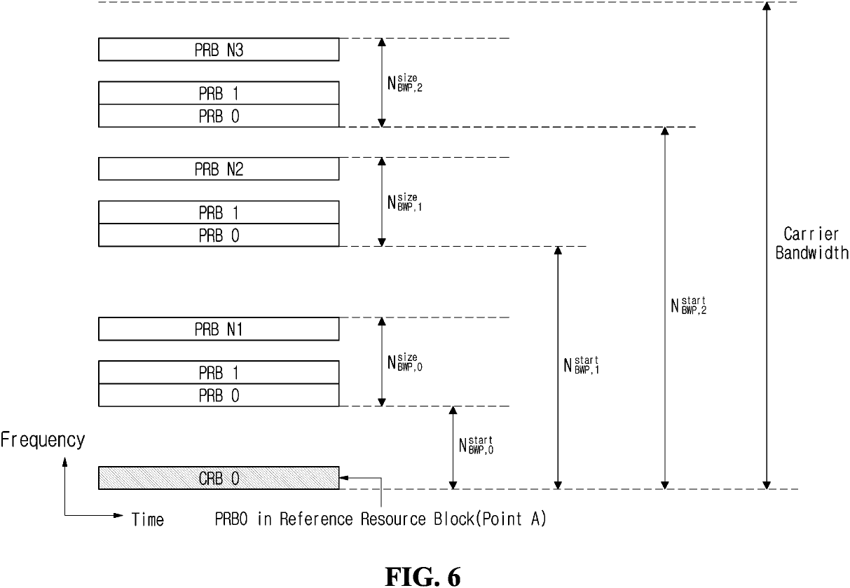

FIG. 6 illustrates an example of a BWP, applicable to the present disclosure. The embodiment of FIG. 6 may be combined with various embodiments of the present disclosure. It is assumed in the embodiment of FIG. 6 that the number of BWPs is 3.

Referring to FIG. 6, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset (N^{start}_{BWP}) from the point A, and a bandwidth (N^{size}_{BWP}). For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

### V2X or Sidelink Communication

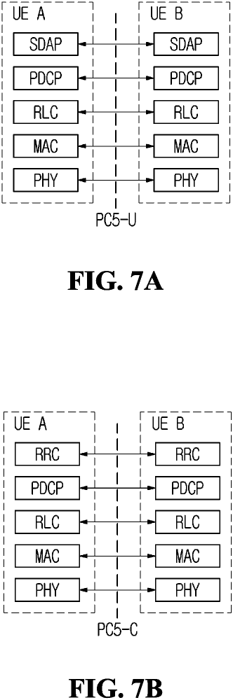

FIGS. 7A and 7B illustrate a radio protocol architecture for a SL communication, applicable to the present disclosure. The embodiment of FIGS. 7A and 7B may be combined with various embodiments of the present disclosure. More specifically, FIG. 7A exemplifies a user plane protocol stack, and FIG. 7B exemplifies a control plane protocol stack.

### Sidelink Synchronization Signal (SLSS) and Synchronization Informaion

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-) configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

For example, based on Table 1, the UE may generate an S-SS/PSBCH block (i.e., S-SSB), and the UE may transmit the S-SS/PSBCH block (i.e., S-SSB) by mapping it on a physical resource.

TABLE 1

■ Time-frequency structure of an S-SS/PSBCH block
In the time domain, an S-SS/PSBCH block consists of ${N}_{\text{symb}}^{\text{S-SSB}}$ OFDM symbols. numbered in
increasing order from 0 to ${N}_{\text{symb}}^{\text{S-SSB}} - 1$ within the S-SS/PSBCH block, where S-PSS, S-SSS,
and PSBCH with associated DM-RS are mapped to symboₗs as given by Table 8.4.3.1-1.
The number of OFDM symbols in an S-SS/PSBCH block ${N}_{\text{symb}}^{\text{S-SSB}} = 13$ for normal cyclic
prefix and ${N}_{\text{symb}}^{\text{S-SSB}} = 11$ for extended cyclic prefix. The first OFDM symbol in an S-
SS/PSBCH block is the first OFDM symbol in the slot.
In the frequency domain, an S-SS/PSBCH block consists of 132 contiguous subcarriers with
the subcarriers numbered in increasing order from 0 to 131 within the sidelink S-
SS/PSBCH block. The quantities k and l represent the frequency and time indices,
respectively, within one sidelink S-SS/PSBCH block.
For an S-SS/PSBCH block, the UE shall use
- antenna port 4000 for transmission of S-PSS, S-SSS, PSBCH and DM-RS for PSBCH;
- the same cyclic prefix length and subcarrier spacing for the S-PSS, S-SSS, PSBCH
and DM-RS for PSBCH.
Table 8.4.3.1-1: Resources within an S-SS/PSBCH block for S-PSS, S-SSS, PSBCH, and
DM-RS.

[image]

### Synchroniztion Acouistion of Sl Terminal

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

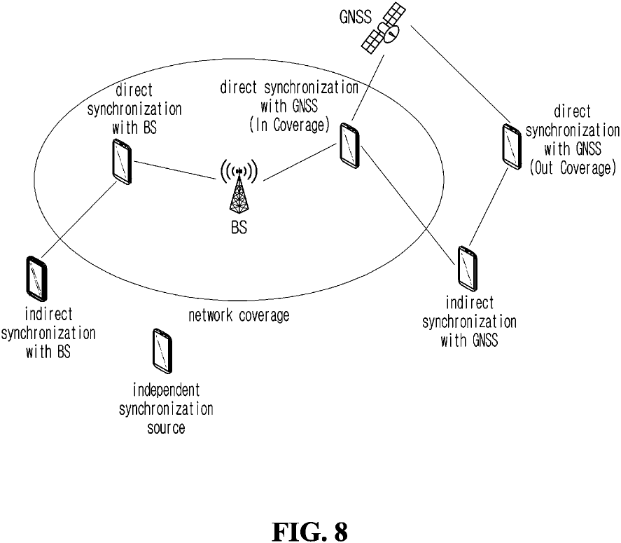

FIG. 8 illustrates a synchronization source or synchronization reference of V2X, applicable to the present disclosure. The embodiment of FIG. 8 may be combined with various embodiments of the present disclosure.

Referring to FIG. 8, in V2X, a UE may be synchronized with a GNSS directly or indirectly through a UE (within or out of network coverage) directly synchronized with the GNSS. When the GNSS is configured as a synchronization source, the UE may calculate a direct subframe number (DFN) and a subframe number by using a coordinated universal time (UTC) and a (pre)determined DFN offset.

Alternatively, the UE may be synchronized with a BS directly or with another UE which has been time/frequency synchronized with the BS. For example, the BS may be an eNB or a gNB. For example, when the UE is in network coverage, the UE may receive synchronization information provided by the BS and may be directly synchronized with the BS. Thereafter, the UE may provide synchronization information to another neighboring UE. When a BS timing is set as a synchronization reference, the UE may follow a cell associated with a corresponding frequency (when within the cell coverage in the frequency), a primary cell, or a serving cell (when out of cell coverage in the frequency), for synchronization and DL measurement.

The BS (e.g., serving cell) may provide a synchronization configuration for a carrier used for V2X or SL communication. In this case, the UE may follow the synchronization configuration received from the BS. When the UE fails in detecting any cell in the carrier used for the V2X or SL communication and receiving the synchronization configuration from the serving cell, the UE may follow a predetermined synchronization configuration.

Alternatively, the UE may be synchronized with another UE which has not obtained synchronization information directly or indirectly from the BS or GNSS. A synchronization source and a preference may be preset for the UE. Alternatively, the synchronization source and the preference may be configured for the UE by a control message provided by the BS.

An SL synchronization source may be related to a synchronization priority. For example, the relationship between synchronization sources and synchronization priorities may be defined as shown in [Table 2] or [Table 3]. [Table 2] or [Table 3] is merely an example, and the relationship between synchronization sources and synchronization priorities may be defined in various manners.

TABLE 2

| | | |
|---|---|---|
| Priority | GNSS-based synchronization | eNB/gNB-based synchronization |
| P0 | GNSS | eNB/gNB |
| P1 | All UEs synchronized directly with GNSS | All UEs synchronized directly with NB/gNB |
| P2 | All UEs synchronized indirectly with GNSS | All UEs synchronized indirectly with eNB/gNB |
| P3 | All other UEs | GNSS |
| P4 | N/A | All UEs synchronized directly with GNSS |
| P5 | N/A | All UEs synchronized indirectly with GNSS |
| P6 | N/A | All other UEs |

TABLE 3

| | | |
|---|---|---|
| Priority Level | GNSS-based synchronization | eNB/gNB-based synchronization |
| P0 | GNSS | eNB/gNB |
| P1 | All UEs synchronized directly with GNSS | All UEs synchronized directly with eNB/gNB |
| P2 | All UEs synchronized indirectly with GNSS | All UEs synchronized indirectly with eNB/gNB |
| P3 | eNB/gNB | GNSS |
| P4 | All UEs synchronized directly with eNB/gNB | All UEs synchronized directly with GNSS |
| P5 | All UEs synchronized indirectly with eNB/gNB | All UEs synchronized indirectly with GNSS |
| P6 | Remaining UE(s) with lower priority | Remaining UE(s) with lower priority |

In [Table 2] or [Table 3], P0 may represent a highest priority, and P6 may represent a lowest priority. In [Table 2] or [Table 3], the BS may include at least one of a gNB or an eNB.

Whether to use GNSS-based synchronization or eNB/gNB- based synchronization may be (pre)determined. In a single-carrier operation, the UE may derive its transmission timing from an available synchronization reference with the highest priority.

For example, the UE may (re)select a synchronization reference, and the UE may obtain synchronization from the synchronization reference. In addition, the UE may perform SL communication (e.g., PSCCH/PSSCH transmission/reception, physical sidelink feedback channel (PSFCH) transmission/reception, S-SSB transmission/reception, reference signal transmission/reception, etc.) based on the obtained synchronization.

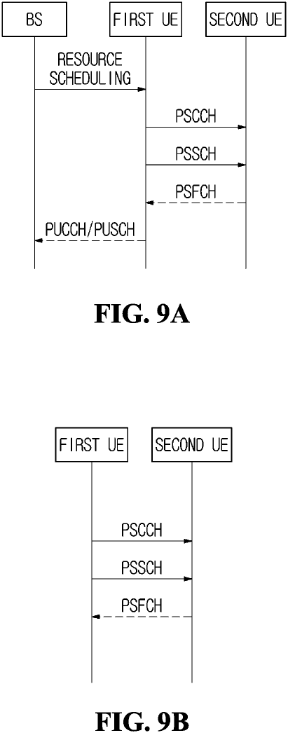

FIGS. 9A and 9B illustrate a procedure of performing V2X or SL communication by a terminal based on a transmission mode, applicable to the present disclosure. The embodiment of FIGS. 9A and 9B may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 9A exemplifies a UE operation related to an LTE transmission mode 1 or an LTE transmission mode 3. Alternatively, for example, FIG. 9B exemplifies a UE operation related to an NR resource allocation mode 1. For example, the LTE transmission mode 1 may be applied to general SL communication, and the LTE transmission mode 3 may be applied to V2X communication.

For example, FIG. 9B exemplifies a UE operation related to an LTE transmission mode 2 or an LTE transmission mode 4. Alternatively, for example, FIG. 9A exemplifies a UE operation related to an NR resource allocation mode 2.

Referring to FIG. 9A, in the LTE transmission mode 1, the LTE transmission mode 3, or the NR resource allocation mode 1, a BS may schedule an SL resource to be used by the UE for SL transmission. For example, a base station may transmit information related to SL resource(s) and/or information related to UL resource(s) to a first UE. For example, the UL resource(s) may include PUCCH resource(s) and/or PUSCH resource(s). For example, the UL resource(s) may be resource(s) for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

Subsequently, the first UE may transmit a PSCCH (e.g., sidelink control information (SCI) or 1^{st}-stage SCI) to a second UE based on the resource scheduling. After then, the first UE may transmit a PSSCH (e.g., 2^{nd}-stage SCI, MAC PDU, data, etc.) related to the PSCCH to the second UE. After then, the first UE may receive a PSFCH related to the PSCCH/PSSCH from the second UE. For example, HARQ feedback information (e.g., NACK information or ACK information) may be received from the second UE through the PSFCH. After then, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling. For example, a format of the DCI may be a DCI format 3_0 or a DCI format 3_1. Table 4 shows an example of a DCI for SL scheduling.

TABLE 4

3GPP TS 38.212
■ Format 3_0
DCI format 3_0 is used for scheduling of NR PSCCH and NR PSSCH in one cell.
The following information is transmitted by means of the DCI format 3_0 with CRC scrambled by SL-RNTI or SL-CS-RMTI:
- Resource pool index - [log₂l] bits, where l is the number of resource pools for transmission configured by the higher layer parameter sl-TxPoolScheduling.
- Time gap - 3 bits determined by higher layer parameter sl-DCI-ToSL-Trans, as defined in clause 8.1.2.1 of [6, TS 38.214]
- HARQ process number - 4 bits as defined in clause 16.4 of [5, TS 38.213]
- New data indicator - 1 bit as defined in clause 16.4 of [5, TS 38.213]
- Lowest index of the subchannel allocation to the initial transmission $- \left[{\text{log}}_{2} \left({N}_{\text{subChannel}}^{\text{SL}}\right)\right]$ bits as defined in clause 8.1.2.2 of [6, TS 38.214]
- SCI format 1-A fields according to clause 8.3.1.1:
- Frequency resource assignment.
- Time resource assignment.
- PSFCH-to-HARQ feedback timing indicator $- \left⌈{log}_{2} {N}_{f b \_ t i m i n g}\right⌉$ bits, where timing N_{fb_timing} is the number of entries in the higher layer parameter sl-PSFCH-ToPUCCH, as defined in clause 16.5 of [5, TS 38.213]
- PUCCH resource indicator- 3 bits as defined in clause 16.5 of [5, TS 38.213].
- Configuration index - 0 bit if the UE is not configured to monitor DCI format 3_0 with CRC scrambled by SL-CS-RNTI; otherwise 3 bits as defined in clause 8.1.2 of [6, TS 38.214]. If the UE is configured to monitor DCI format 3_0 with CRC scrambled by SL-CS-RNTI, this field is reserved for DCI format 3_0 with CRC scrambled by SL-RNTI.
- Counter sidelink assignment index - 2 bits
- 2 bits as defined in clause 16.5.2 of [5, TS 38.213] if the UE is configured with pdsch-HARQ-ACK-Codebook = dynamic
- 2 bits as defined in clause 16.5.1 of [5, TS 38.213] if the UE is configured with pdsch-HARQ-ACK-Codebook = semi-static
- Padding bits, if required
■ Format 3_1
DCI format 3_1 is used for scheduling of LTE PSCCH and LTE PSSCH in one cell.
The following information is transmitted by means of the DCI format 3_1 with CRC scrambled by SL-L-CS-RNTI:
- Timing offset - 3 bits determined by higher layer parameter sl-TimeOffsetEUTRA, as defined in clause 16.6 of [5, TS 38.213]
- Carrier indicator -3 bits as defined in 5.3.3.1.9A of [11, TS 36.212].
- Lowest index of the subchannel allocation to the initial transmission - $\left⌈{\text{log}}_{2} \left({N}_{\text{subchannel}}^{\text{SL}}\right)\right⌉$ bits as defined in 5.3.3.1.9A of [11, TS 36.212].
- Frequency resource location of initial transmission and retransmission, as defined in 5.3.3.1.9A of [11, TS 36.212]
- Time gap between initial transmission and retransmission, as defined in 5.3.3.1.9A of [11, TS 36.212]
- SL index - 2 bits as defined in 5.3.3.1.9A of [11, TS 36.212]
- SL SPS configuration index - 3 bits as defined in clause 5.3.3.1.9A of [11, TS 36.212].
- Activation/release indication - 1 bit as defined in clause 5.3.3.1.9A of [11, TS 36.212].

Referring to FIG. 9B, in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannel(s). For example, subsequently, a first UE which has selected resource(s) from a resource pool by itself may transmit a PSCCH (e.g., sidelink control information (SCI) or 1^{st}-stage SCI) to a second UE by using the resource(s). After then, the first UE may transmit a PSSCH (e.g., 2^{nd}-stage SCI, MAC PDU, data, etc.) related to the PSCCH to the second UE. In step S8030, the first UE may receive a PSFCH related to the PSCCH/PSSCH from the second UE.

Referring to FIGS. 9A and 9B, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1^{st} SCI, a first SCI, a 1^{st}-stage SCI or a 1^{st}-stageSCI format, and a SCI transmitted through a PSSCH may be referred to as a 2^{nd} SCI, a second SCI, a 2^{nd}-stage SCI or a 2^{nd}-stage SCI format. For example, the 1^{st}-stageSCI format may include a SCI format 1-A, and the 2^{nd}-stage SCI format may include a SCI format 2-A and/or a SCI format 2-B. Table 5 shows an example of a 1^{st}-stageSCI format.

TABLE 5

3GPP TS 38.212
■ SCI format 1-A
SCI format 1-A is used for the scheduling of PSSCH and 2^{nd}-stage-SCI on PSSCH
The following information is transmitted by means of the SCI format 1-A:
- Priority - 3 bits as specified in clause 5.4.3.3 of [12, TS 23.287] and clause 5.22.1.3.1 of [8, TS 38.321].
- Frequency resource assignment - $\left⌈{\text{log}}_{2} \left(\frac{{N}_{\text{subChannel}}^{\text{SL}} \left({N}_{\text{subChannel}}^{\text{SL}} + 1\right)}{2}\right)\right⌉$ bits when the value of the higher layer parameter sl-MaxNumberPerReserve is configured to 2; otherwise
$\left⌈{\text{log}}_{2} \left(\frac{{N}_{\text{subChannel}}^{\text{SL}} \left({N}_{\text{SubChannel}}^{\text{SL}} + 1\right) \left(2 {N}_{\text{subChannel}}^{\text{SL}} + 1\right)}{5}\right)\right⌉$ bits when the value of the higher layer parameter sl-MaxNumPerReserve is configured to 3, as defined in clause 8.1.2.2 of [6.TS 38.214].
- Time resource assignment - 5 bits when the value of the higher layer parameter sl-MaxNumPerReserve is configured to 2: otherwise 9 bits when the value of the higher layer parameter sl-MaxNumPerReserve is configured to 3, as defined in clause 8.1.2.1 of [6. TS 38.214].
- Resource reservation period -[log₂N_{rsv,period}] bits as defined in clause 8.1.4 of [6. TS 38.214], where N_{rsv_period} is the number of entries in the higher layer parameter sl-ResourceReservePeriodList, if higher layer parameter sl-MultiReserveResource is configured; 0 bit otherwise.
- DMRS pattern $- \left⌈{log}_{2} {N}_{p a t t e r n}\right⌉$ bits as defined in clause 8.4.1.1.2 of [4, TS 38.211]. where Nₚₐₜₜₑᵣₙ is the number of DMRS patterns configured by higher layer parameter sl-PSSCH-DMRS-TimePatternList.
- 2^{nd}-stage SCI format - 2 bits as defined in Table 8.3.1. 1-1.
- Beta_offset indicator - 2 bits as provided by higher layer parameter sl-BetaOffsets2ndSCIand Table 8.3.1.1-2.
- Number of DMRS port - 1 bit as defined in Table 8.3.1.1-3.
- Modulation and costing scheme - 5 bits as defined in clause 8.1.3 of [6, TS 38.214].
- Additional MCS table indicator - as defined in clause 8.1.3.1 of [6, TS 38.214]: 1 bit if one MCS table is configured by higher layer parameter sl-Additional-MCS-Table: 2 bits if two MCS tables are configured by higher layer parameter sl-Additional-MCS-Table: 0 bit otherwise.
- PSFCH overhead indication - 1 bit as defined clause 8.1.3.2. of [6. TS 38.214] if higher layer parameter sl-PSFCH-Period = 2 or 4; 0 bit otherwise.
- Reserved - a number of bits as determined by higher layer parameter sl-NumReservedBits, with value set to zero.
Table 8.3.1.1-1: 2^{nd}-stage SCI formats [image]
Table 8.3.1.1-2: Mapping of Beta_offset indicator values to indexes in Table 9.3-2 of [5, TS38.213]

[image]

Table 6 shows an example of a 2^{nd}-stage SCI format.

TABLE 6

3GPP TS 38.212
SCI format 2-A
SCI format 2-A is used for the decoding of PSSCH, with HARQ operation when HARQ-ACK information includes ACK or NACK. when HARQ-ACK information includes only NACK, or when there is no feedback of HARQ-ACK information.
The following information is transmitted by means of the SCI format 2-A:
- HARQ process number - 4 bits as defined in clause 16.4 of [5, TS 38.213].
- New data indicator - 1 bit as defined in clause 16.4 of [5, TS 38.213].
- Redundancy version - 2 bits as defined in clause 16.4 of [6, TS 38.214].
- Source ID - 8 bits as defined in clause 8.1 of [6, TS 38.214].
- Destination ID - 16 bits as defined in clause 8.1 of [6, TS 38.214].
- HARQ feedback enabled/disabled indicator - 1 bit as defined in clause 16.3 of [5, TS 38.213].
- Cast type indicator - 2 bits as defined in Table 8.4.1.1-1.
- CSI request - 1 bit as defined in clause 8.2.1 of [6, TS 38.214].
Table 8.4.1.1-1: Cast type indicator [image]
SCI format 2-B
SCI format 2-B is used for the decoding of PSSCH, with HARQ operation when HARQ-ACK
information includes only NACK, or when there is no feedback of HARQ-ACK information.
The following information is transmitted by means of the SCI format 2-B:
- HARQ process number - 4 bits as defined in clause 16.4 of [5, TS 38.213].
- New data indicator - 1 bit as defined in clause 16.4 of [5, TS 38.213].
- Redundancy version - 2 bits as defined in clause 16.4 of [6, TS 38.214].
- Source ID - 8 bits as defined in clause 8.1 of [6, TS 38.214].
- Destination ID - 16 bits as defined in clause 8.1 of [6, TS 38.214].
- HARQ feedback enabled/disabled indicator - 1 bit as defined in clause 16.8 of [5, TS 38.213]
- Zone: ID - 12 bits as defined in clause 5.8.11 of [9, TS 38.331].
- Communication range requirement - 4 bits determined by higher layer parameter sl-ZoneConfigMCR-Index.

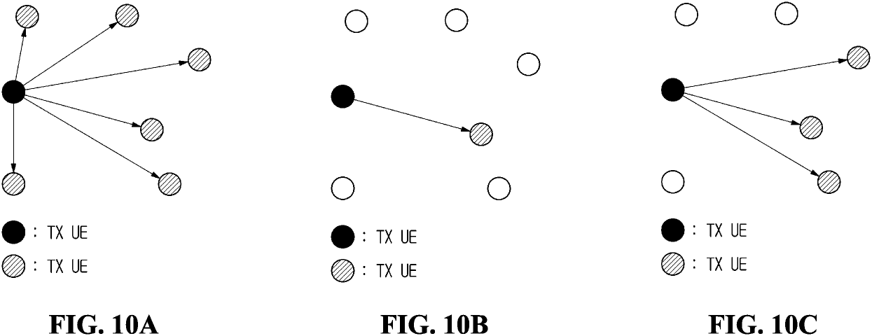

FIGS. 10A to 10C illustrate three cast types applicable to the present disclosure. The embodiment of FIGS. 10A to 10C may be combined with various embodiments of the present disclosure.

Specifically, FIG. 10A exemplifies broadcast-type SL communication, FIG. 10B exemplifies unicast type-SL communication, and FIG. 10C exemplifies groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

### Sl Measurement and Reporting

For the purpose of QoS prediction, initial transmission parameter setting, link adaptation, link management, admission control, and so on, SL measurement and reporting (e.g., an RSRP or an RSRQ) between UEs may be considered in SL. For example, the receiving UE may receive an RS from the transmitting UE and measure the channel state of the transmitting UE based on the RS. Further, the receiving UE may report CSI to the transmitting UE. SL-related measurement and reporting may include measurement and reporting of a CBR and reporting of location information. Examples of CSI for V2X include a channel quality indicator (CQI), a precoding matrix index (PMI), a rank indicator (RI), an RSRP, an RSRQ, a path gain/pathloss, an SRS resource indicator (SRI), a CSI-RS resource indicator (CRI), an interference condition, a vehicle motion, and the like. CSI reporting may be activated and deactivated depending on a configuration.

For example, the transmitting UE may transmit a channel state information-reference signal (CSI-RS) to the receiving UE, and the receiving UE may measure a CQI or RI using the CSI-RS. For example, the CSI-RS may be referred to as an SL CSI-RS. For example, the CSI-RS may be confined to PSSCH transmission. For example, the transmitting UE may transmit the CSI-RS in PSSCH resources to the receiving UE.

### Specific Embodiments of the Present Disclosure

The present disclosure relates to a beam failure recovery procedure based on sidelink in a wireless communication system and relates to technology for detecting a beam failure during sidelink communication and resolving a beam failure situation.

Sidelink communication may be utilized for communication between vehicles, that is, V2X communication. For high-capacity data transmission in vehicle-related applications such as autonomous driving, communication in a mmWave band may be performed. In order to perform communication in the mmWave band, beamforming to compensate for high path attenuation is required. However, due to high path attenuation and penetration attenuation characteristics of millimeter waves, a link failure situation may occur when a direct path is blocked by an obstacle such as a vehicle. In addition, a beam failure situation for aligned beams may occur due to a change in a relative positional relationship between two devices performing communication. Accordingly, the present disclosure proposes a technology for recovering a communication connection in various connection failure or beam failure situations.

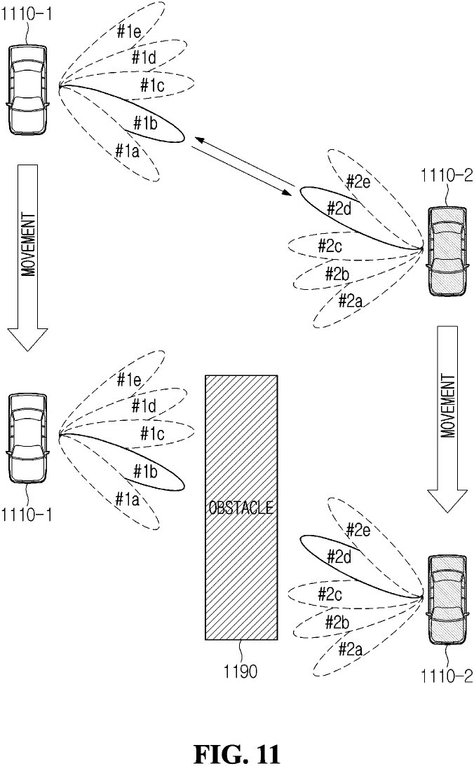

FIG. 11 illustrates an example of a beam failure situation in a wireless communication system according to an embodiment of the present disclosure.

Referring to FIG. 11, a first terminal 1110-1 included in a first vehicle and a second terminal 1110-2 included in a second vehicle perform communication based on sidelink. Beamforming is essential for millimeter wave communication due to high path attenuation. Accordingly, the first terminal 1110-1 and the second terminal 1110-2 perform communication using beam #1b and beam #2d directed toward each other. At this time, as the first vehicle and the second vehicle move, a path between beam #1b of the first terminal 1110-1 and beam #2d of the second terminal 1110-2 is blocked.

In the case of communication based on beamforming, when a direct path of radio waves is blocked by an obstacle, communication is almost impossible due to the characteristics of millimeter waves in which diffraction hardly occurs. In general, devices manage candidate beams other than the currently used beam by performing beam tracking, but the candidate beams are highly likely to have propagation paths similar to those of beams currently used for communication. Accordingly, when a beam currently in use is blocked, there is a high probability that candidate beams are also blocked. In addition, when a relative direction between two terminals in communication is rapidly changed (e.g., a sudden rotation of any one vehicle, etc.), a beam currently used for communication may no longer be effective. That is, a beam failure may occur due to appearance of an obstacle or a rapid relative direction change. In this way, when a beam failure occurs due to beam blocking, etc., the present disclosure proposes the following embodiments in order to notify a counterpart device of this situation and switch the link to another beam capable of communication.

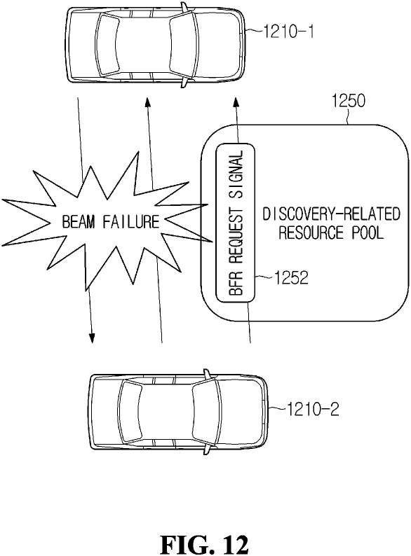

FIG. 12 illustrates a concept of a beam failure recovery procedure based on sidelink in a wireless communication system according to an embodiment of the present disclosure. Referring to FIG. 12, a beam failure situation occurs while a first terminal 1210-1 and a second terminal 1210-1 communicate. Accordingly, the second terminal 1210-1 may transmit a beam failure recovery request signal 1252 to trigger a beam failure recovery procedure. At this time, according to an embodiment, the second terminal 1210-1 transmits a beam failure recovery request signal 1262 using a resource pool 1250 related to discovery.

Discovery refers to a procedure performed to discover neighboring terminals for sidelink communication. For example, discovery is performed by exchanging a discovery signal and a discovery response signal. According to an embodiment, the discovery signal may include a synchronization signal, system information, and a reference signal, and the discovery response signal may be transmitted in response to reception of the discovery signal. Here, at least one resource pool for transmitting the discovery signal and the discovery response signal, that is, a resource pool related to discovery, may be allocated.

A terminal according to various embodiments uses a resource pool related to discovery for triggering of a beam failure recovery procedure. In other words, a terminal according to various embodiments may transmit a beam failure recovery message or signal using a discovery signal or a discovery response signal. That is, according to various embodiments, the discovery signal or the discovery response signal may include information related to beam failure recovery.

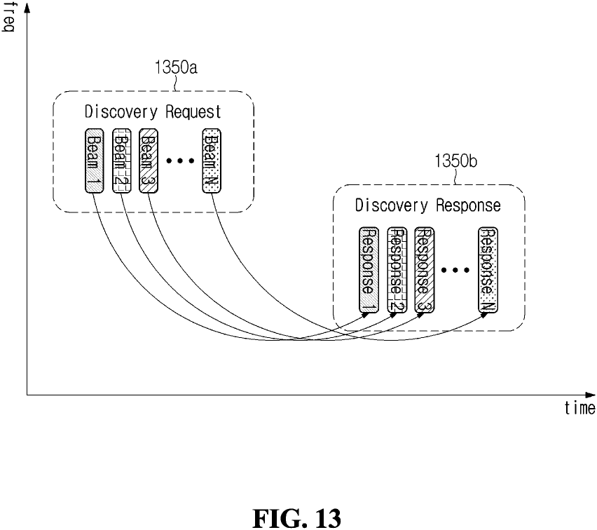

Here, the resource pool related to discovery may be divided into a discovery resource pool allocated to transmit a discovery signal and a discovery response resource pool allocated to transmit a discovery response signal. Here, the discovery signal may be referred to as a discovery request signal, and the discovery resource pool may be referred to as a discovery request resource pool. The relationship between the discovery resource pool and the discovery response resource pool is shown in FIG. 13 below.

FIG. 13 illustrates an example of resources related to discovery in a wireless communication system according to an embodiment of the present disclosure. FIG. 13 illustrates a discovery resource pool 1350a containing discovery resources for sidelink communication and a discovery response resource pool 1350b containing discovery response resources.

Referring to FIG. 13, the discovery resource pool 1350a includes a plurality of discovery resources, and the discovery response resource pool 1350b includes a plurality of discovery response resources. A first terminal desiring to perform sidelink communication may transmit a discovery signal through the discovery resource pool 1350a in order to discover a neighboring communication counterpart without help from a base station. In the case of the millimeter wave band, the first terminal may repeatedly transmit a discovery signal through discovery resources in the discovery resource pool 1350a using a plurality of beams.

Among terminals that have received the discovery signal, a second terminal that is interested in the service of the first terminal and wants to communicate with the first terminal may transmit a discovery response signal to the first terminal through the discovery response resource in the discovery response resource pool 1350b. At this time, the plurality of discovery resources correspond to the plurality of discovery response resources. Accordingly, the second terminal transmits the discovery response signal through the discovery response resource corresponding to the discovery resource in which the discovery signal was detected. The first terminal that has transmitted the discovery signal may receive the discovery response signal by monitoring the discovery response resource.

The discovery response resource corresponding to the discovery resource may be explicitly indicated by information included in the discovery signal. Alternatively, the discovery response resource corresponding to the discovery resource may be relatively inferred from a time/frequency domain location of the discovery signal resource. In this case, the relative positional relationship (e.g., time/frequency offset) between the discovery resource and the discovery response resource may be predefined or delivered through separate signaling.

As described above, the discovery resource and the discovery response resource may be utilized for a beam failure recovery procedure. According to an embodiment, when a beam failure situation occurs, the second terminal may transmit a beam failure recovery request signal using a sidelink discovery response resource. The first terminal may continuously monitor the sidelink discovery response resource even after sidelink connection is established, and may receive a beam failure recovery request.

According to another embodiment, when a beam failure situation occurs, the second terminal may transmit a beam failure recovery request signal using a sidelink discovery resource. The first terminal may continuously monitor the sidelink discovery resource even after sidelink connection is established, and receive a beam failure recovery request.

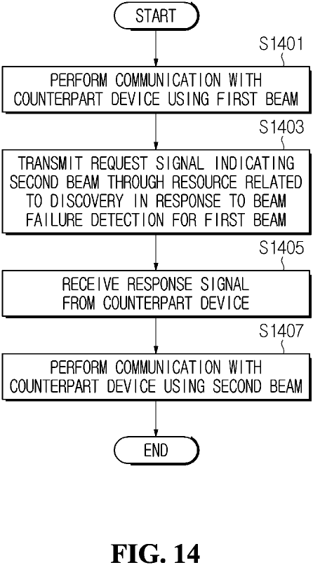

FIG. 14 illustrates an example of a procedure for requesting beam failure recovery in a wireless communication system according to an embodiment of the present disclosure. FIG. 14 illustrates a method of operating a terminal transmitting a request for a beam recovery failure.

Referring to FIG. 14, in step S1401, the terminal performs communication with a counterpart device using a first beam. Here, the counterpart device may be a terminal or a road side unit (RSU). The first beam is one of a plurality of transmit beams available in the counterpart device, and may be an optimal beam selected through a beam alignment procedure.

In step S1403, the terminal transmits a request signal including information indicating a second beam through a resource related to discovery in response to beam failure detection for the first beam. For example, the request signal may indicate a second beam using explicit signaling (e.g., an indicator, parameter, etc.) or an implicit method (e.g., transmission through a resource related to the second beam). According to an embodiment, the terminal may detect a beam failure of the first beam based on measurement of the signal received from the counterpart device and transmit a request signal requesting use of the second beam. In this case, the request signal may be transmitted through a resource related to discovery, for example, a discovery resource or a discovery response resource. According to an embodiment, the request signal may be expressed by at least one field included in the discovery signal or the discovery response signal. Alternatively, according to another embodiment, the request signal may be defined as a signal or message in a format different from that of the discovery signal or the discovery response signal transmitted through the discovery resource or the discovery response resource.

In step S1405, the terminal receives a response signal from the counterpart device. The response signal may be received through a resource related to discovery or a resource related to sidelink data. That is, the terminal receives a response signal indicating that the counterpart device has received the request signal. According to an embodiment, the response signal may include information indicating whether use of the second beam is accepted or information indicating use of the third beam. In this embodiment, it is assumed that the use of the second beam is accepted.

In step S1407, the terminal performs communication with the counterpart device using the second beam. That is, the terminal may confirm that the use of the second beam is accepted through the response signal and receive a signal transmitted using the second beam from the counterpart device. At this time, the terminal may use a receive beam that is optimally paired with the second beam.

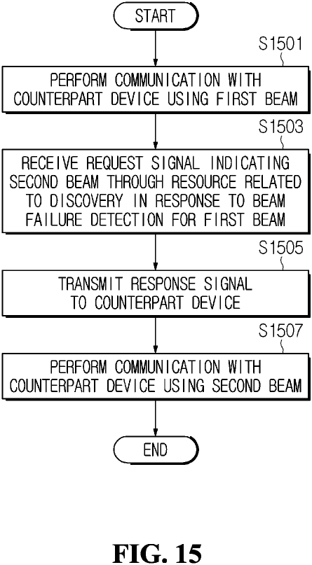

FIG. 15 illustrates an example of a procedure for responding to a request for beam failure recovery in a wireless communication system according to an embodiment of the present disclosure. FIG. 15 illustrates a method of operating a terminal receiving a request for a beam recovery failure.

Referring to FIG. 15, in step S1501, the terminal performs communication with a counterpart device using a first beam. Here, the counterpart device may be a terminal or an RSU. The first beam is one of a plurality of transmit beams available in the terminal and may be an optimal beam selected through a beam alignment procedure. That is, the terminal transmits a signal to the counterpart device using the first beam.

In step S1503, the terminal receives a request signal including information indicating a second beam transmitted through a resource related to discovery in response to beam failure detection for the first beam. For example, the request signal may indicate a second beam using explicit signaling (e.g., an indicator, parameter, etc.) or an implicit method (e.g., transmission through a resource related to the second beam). In this case, the request signal may be received through a resource related to discovery, for example, a discovery resource or a discovery response resource. Also, the request signal may be received using a beam in a different direction from a beam used for communication with the counterpart device. According to an embodiment, the request signal may be expressed by at least one field included in the discovery signal or the discovery response signal. Alternatively, according to another embodiment, the request signal may be defined as a signal or message in a format different from that of the discovery signal or the discovery response signal transmitted through the discovery resource or the discovery response resource.

In step S1505, the terminal transmits a response signal to the counterpart device. The response signal may be transmitted through a resource related to discovery or a resource related to sidelink data. That is, the terminal transmits a response signal indicating that the request signal has been received. According to an embodiment, the response signal may include information indicating whether use of the second beam is accepted or information indicating use of the third beam. In this embodiment, it is assumed that the use of the second beam is accepted.

In step S1507, the terminal performs communication with the counterpart device using the second beam. That is, after notifying through the response signal that the use of the second beam is accepted, the terminal may transmit a signal to the counterpart device using the second beam.

In the embodiments described with reference to FIGS. 14 and 15, a beam failure may be detected based on measurement of a signal transmitted from the counterpart device. For example, the signal may include a reference signal, and a beam failure may be detected based on a result of comparison of signal quality of the reference signal and a threshold. As another example, the signal may include a data signal, and a beam failure may be detected based on a decoding failure of the data signal.

According to an embodiment described with reference to FIGS. 14 and 15, a request signal for beam failure recovery may be transmitted through a discovery response resource. In some cases, the first terminal transmits the request signal through the discovery response resource, and the second terminal receives the request signal through the discovery response resource. The second terminal may identify the second beam indicated by the request signal, that is, an alternative beam, based on the receive beam used at the timing at which the request signal was detected. The discovery response resource corresponds to the discovery resource, and a receive beam corresponding to a transmit beam used in the discovery resource is used in the discovery response resource according to beam reciprocity. Accordingly, the request signal may be understood as implicitly indicating a transmit beam used in a discovery resource corresponding to a discovery response resource carrying the request signal. That is, the second terminal, which has received the request signal, may interpret the request signal as indicating a transmit beam corresponding to a receive beam used when receiving the request signal. Thereafter, the second terminal transmits a response signal through another discovery resource or a separate resource.

As a specific example, the first terminal transmits a discovery signal using beam #1 in discovery resource #Q1, beam #2 in resource #Q2, and beam #3 in resource #Q3. The second terminal may detect the discovery signal by monitoring all of discovery resource #Q1, resource #Q2, and resource #Q3. If the discovery signal detected in resource #Q2 is the best, the second terminal transmits a request signal for beam failure recovery through a discovery response resource corresponding to resource #Q2. In this case, a beam used by the second terminal is a transmit beam corresponding to a receive beam used when detecting the discovery signal. Accordingly, the first terminal monitors discovery response resources corresponding to the discovery resources, that is, resource #Q1, resource #Q2, and resource #Q3, that is, resource #P1, resource #P2, and resource #P3, and detect a response signal in #P2. Through this, the first terminal may determine that the transmit beam used in resource #Q2 corresponding to discovery response resource #P2 is selected by the second terminal. Then, if beam refinement is required, the first terminal and the second terminal may perform a beam refinement procedure and resume communication.

According to an embodiment described with reference to FIGS. 14 and 15, a request signal for beam failure recovery may be transmitted through a discovery resource. In this case, the first terminal transmits the request signal through the discovery resource, and the second terminal receives the request signal through the discovery resource. The second terminal may identify a second beam to replace the currently used beam, that is, an alternative beam, based on a receive beam used at the timing at which the request signal was detected. In this case, the request signal may be understood as implicitly indicating a transmit beam corresponding to a receive beam used when the request signal is detected. Then, the second terminal may transmit a response signal through the discovery response resource. A discovery resource corresponds to a discovery response resource, and a receive beam corresponding to a transmit beam used in the discovery resource is used in the discovery response resource according to beam reciprocity. Accordingly, the second terminal transmits a response signal for beam failure recovery through a discovery response resource corresponding to a discovery resource to which the received request signal is mapped.

As a specific example, the first terminal transmits a request signal for beam failure recovery using beam #1 in discovery resource #Q1, beam #2 in resource #Q2, and beam #3 in resource #Q3. The second terminal may detect a request signal for beam failure recovery by monitoring all of discovery resource #Q1, resource #Q2, and resource #Q3. If the signal detected in resource #Q2 is the best, the second terminal transmits a response signal through a discovery response resource corresponding to resource #Q2. At this time, the second terminal may determine that the receive beam used in resource #Q2 in which the request signal was detected has been requested by the first terminal as an alternative beam. In response to the request signal, the second terminal may transmit a response signal for beam failure recovery through a discovery response resource (e.g., resource #P2) corresponding to resource #Q2. At this time, the beam used by the second terminal is a transmit beam corresponding to a receive beam used in resource #Q2 in which the request signal was detected. Accordingly, the first terminal may monitor discovery response resources, that is, resource #P1, resource #P2, and resource #P3, and receive a response signal in resource #P2. Then, if beam refinement is required, the first terminal and the second terminal may perform a beam refinement procedure and resume communication.

In the embodiments described with reference to FIGS. 14 and 15, a request signal corresponding to beam failure detection is transmitted by a device that receives a signal transmitted using a transmit beam related to a beam failure. In other words, in the above-described embodiments, the request signal for triggering beam failure recovery is transmitted by the device that has measured the transmit beam related to the beam failure. That is, the aforementioned beam failure recovery procedure starts and proceeds to change the transmit beam of the counterpart device. Independently of this, a beam failure recovery procedure for its own transmit beam may be triggered and performed by the counterpart device. That is, a beam failure recovery procedure according to various embodiments may be independently performed by each of the two devices performing sidelink communication.

According to an embodiment, beam failure recovery procedures of two terminals communicating with each other may be serially performed. For example, when the first terminal transmits a beam failure recovery request signal for the transmit beam of the second terminal, the second terminal may transmit a beam failure recovery response signal and simultaneously transmit a beam failure recovery request signal for the transmit beam of the first terminal. That is, the second terminal may transmit a signal including a response signal for a beam failure recovery procedure requested by the first terminal and a request signal for a beam failure recovery procedure triggered by the second terminal. That is, the response signal for the beam failure recovery procedure requested by the first terminal may be included in the response signal for the beam failure recovery procedure requested by the first terminal in a piggyback format.

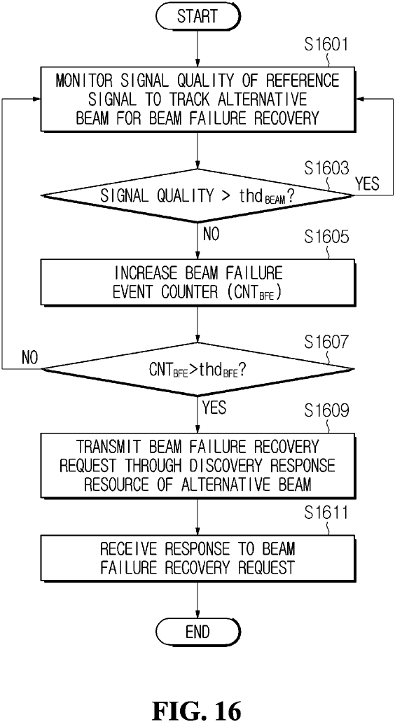

FIG. 16 illustrates an example of a procedure for requesting beam failure recovery using a discovery resource in a wireless communication system according to an embodiment of the present disclosure. FIG. 16 illustrates a method of operating a terminal requesting beam failure recovery through a discovery response resource.

Referring to FIG. 16, in step S1601, the terminal monitors signal quality of a reference signal to track an alternative beam for beam failure recovery. That is, the terminal monitors reference signals transmitted from a counterpart terminal and stores information related to at least one alternative beam having relatively good signal quality (e.g., RSRP, SNR, etc.) among the reference signals.

In step S1603, the terminal checks whether the signal quality is greater than a threshold (hereinafter referred to as ‘thd_{BEAM}’). In other words, the terminal checks whether the signal quality of the reference signal transmitted using a transmit beam (hereinafter ‘) of the counterpart terminal which is currently being used for communication is greater than thd_{BEAM}. That is, the terminal tracks the alternative beam and simultaneously monitors signal quality of the beam in use. If the signal quality of the beam in use is greater than thd_{BEAM}, the terminal returns to step S1601.

On the other hand, if the signal quality of the beam in use is less than or equal to thd_{BEAM}, in step S1605, the terminal increases the value of a beam failure event counter (hereinafter referred to as ‘CNT_{BFE}’). The beam failure event counter is a variable for detecting a beam failure and is initially initialized to 0.

In step S1607, the terminal checks whether the value of CNT_{BFE} is greater than a threshold for beam failure determination (hereinafter referred to as ‘thd_{BFE}’). If the value of CNT_{BFE} is less than or equal to thd_{BFE}, the terminal returns to step S1601.

If the value of CNT_{BFE} is greater than thd_{BFE}, in step S1609, the terminal transmits a beam failure recovery request through the discovery response resource of the alternative beam. That is, if the beam in use is less than thd_{BEAM} but the same event occurs more times than thd_{BFE}, the terminal determines that a beam failure situation has occurred and transmits a beam failure recovery request signal. At this time, the beam failure recovery request signal is transmitted through a resource related to the alternative beam. Here, the resource associated with the alternative beam refers to a discovery resource through which a discovery signal is transmitted using a beam having a quasi co-located (QCL) relationship with the alternative beam or a discovery response resource corresponding to the discovery resource.

In step S1611, the terminal receives a response to the beam failure recovery request. That is, the terminal receives a response signal to the beam failure recovery request signal from the counterpart terminal. Accordingly, the counterpart terminal then uses the alternative beam for sidelink communication with the terminal.

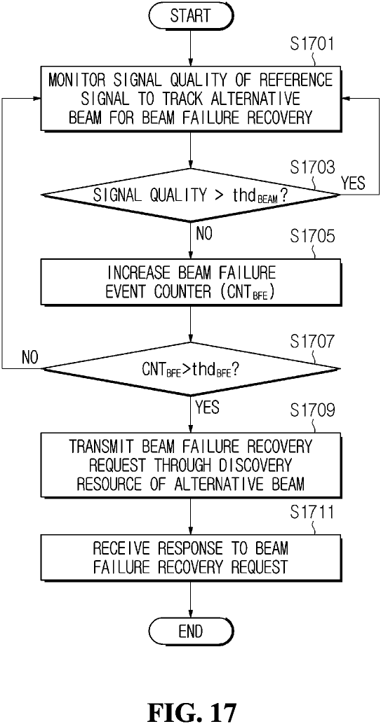

FIG. 17 illustrates another example of a procedure for requesting beam failure recovery using a discovery response resource in a wireless communication system according to an embodiment of the present disclosure. FIG. 17 illustrates a method of operating a terminal requesting beam failure recovery through a discovery resource.

Referring to FIG. 17, in step S1701, the terminal monitors signal quality of a reference signal to track an alternative beam for beam failure recovery. That is, the terminal monitors reference signals transmitted from a counterpart terminal and stores information related to at least one alternative beam having relatively good signal quality (e.g., RSRP, SNR, etc.) among the reference signals.

In step S1703, the terminal checks whether the signal quality is greater than a threshold (hereinafter referred to as ‘thdBEAM’). In other words, the terminal checks whether the signal quality of the reference signal transmitted using a transmit beam (hereinafter ‘) of the counterpart terminal which is currently being used for communication is greater than thdBEAM. That is, the terminal tracks the alternative beam and simultaneously monitors signal quality of the beam in use. If the signal quality of the beam in use is greater than thdBEAM, the terminal returns to step S1701.

On the other hand, if the signal quality of the beam in use is less than or equal to thdBEAM, in step S1705, the terminal increases the value of a beam failure event counter (hereinafter referred to as ‘CNT_{BFE}’). The beam failure event counter is a variable for detecting a beam failure and is initially initialized to 0.

In step S1607, the terminal checks whether the value of CNT_{BFE} is greater than a threshold for beam failure determination (hereinafter referred to as ‘thd_{BFE}’). If the value of CNT_{BFE} is less than or equal to thd_{BFE}, the terminal returns to step S1701.

If the value of CNT_{BFE} is greater than thd_{BFE}, in step S1709, the terminal transmits a beam failure recovery request through the discovery resource of the alternative beam. That is, if the beam in use is less than thdBEAM but the same event occurs more times than thd_{BFE}, the terminal determines that a beam failure situation has occurred and transmits a beam failure recovery request signal. At this time, the beam failure recovery request signal is transmitted through the discovery resource. In this case, the beam failure recovery request signal may be swept using a plurality of transmit beams through discovery resources. The beam failure recovery request signal is included in the discovery signal, and the discovery signal may include at least one of an indicator indicating a beam failure recovery request or identification information (e.g., UE ID) of the counterpart terminal.

In step S1711, the terminal receives a response to the beam failure recovery request. That is, the terminal receives a response signal to the beam failure recovery request signal from the counterpart terminal. In this case, the response signal may be received through a discovery response resource corresponding to a discovery resource used to transmit the beam failure recovery request signal. Accordingly, the counterpart terminal then uses the alternative beam for sidelink communication with the terminal.

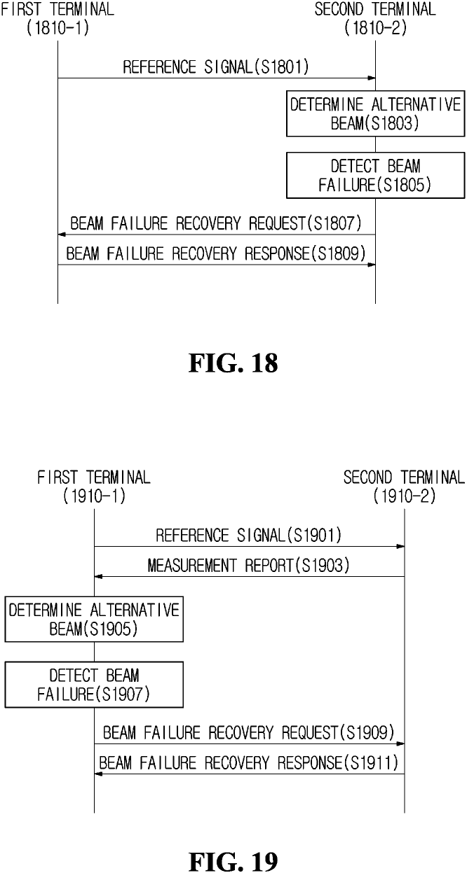

FIG. 18 illustrates an example of a beam failure recovery procedure in a wireless communication system according to an embodiment of the present disclosure. FIG. 18 illustrates signal exchange between a first terminal 1810-1 and a second terminal 1810-2 for a beam failure recovery procedure for a transmit beam of the first terminal 1810-1.

Referring to FIG. 18, in step S1801, the first terminal 1810-1 transmits reference signals to the second terminal 1810-2. The reference signals may be swept using different transmit beams. The reference signals may be transmitted dedicatedly for measurement by the second terminal 1810-2 or commonly transmitted for measurement of a plurality of unspecified terminals. For example, the commonly transmitted reference signals may be at least part of a discovery signal.

In step S1803, the second terminal 1810-2 determines an alternative beam. In other words, the second terminal 1810-2 may determine another beam to replace the transmit beam currently being used by the first terminal 1810-1. The second terminal 1810-2 may determine the alternative beam based on the measurement results of the reference signals. At this time, the receive beam used by the second terminal 1810-2 may also be changed.

In step S1805, the second terminal 1810-2 detects a beam failure. The beam failure may be detected based on the signal quality of the transmit beam in use. Even if another beam to replace the transmit beam in use is determined, if the signal quality of the transmit beam in use is sufficient, the second terminal 1810-2 may determine that there is no beam failure situation. However, if the signal quality of the transmit beam in use is not sufficient, the second terminal 1810-2 determines that a beam failure situation has occurred. Insufficient signal quality may be determined by deterioration of signal quality over a threshold number of times.

In step S1807, the second terminal 1810-2 transmits a beam failure recovery request signal to the first terminal 1810-1. The beam failure recovery request signal explicitly or implicitly includes information on an alternative beam.

In step S1809, the first terminal 1810-1 transmits a beam failure recovery response signal to the second terminal 1810-2. According to an embodiment, the beam failure recovery response signal may indicate whether the alternative beam is accepted. According to another embodiment, when use of the alternative beam is rejected, the beam failure recovery response signal may further include information indicating another alternative beam.

In the embodiment described with reference to FIG. 18, a device performing measurement (e.g., the second terminal 1810-2) determines a beam failure and transmits a request signal triggering beam failure recovery. However, according to another embodiment, a device using a transmit beam related to a beam failure (e.g., the first terminal 1810-1) may transmit a request signal triggering beam failure recovery. For example, the first terminal 1810-1 may determine occurrence of a beam failure situation based on a measurement report and transmit a request signal for triggering beam failure recovery.

In the embodiment described with reference to FIG. 18, the second terminal 1810-2 detects a beam failure based on the measurement of the reference signal. According to another embodiment, the second terminal 1810-2 may detect a beam failure based on a decoding failure of data. Specifically, when decoding failures occur more than a threshold number of times consecutively, the second terminal 1810-2 may determine that a beam failure situation has occurred. In this case, the reference signal of step S1801 may be replaced with a data packet (e.g., a transport block, a code block, or a code block group).

FIG. 19 illustrates another example of a beam failure recovery procedure in a wireless communication system according to an embodiment of the present disclosure. FIG. 19 illustrates signal exchange between a first terminal 1910-1 and a second terminal 1910-2 for a beam failure recovery procedure for a transmit beam of the first terminal 1910-1.

Referring to FIG. 19, in step S1901, the first terminal 1910-1 transmits reference signals to the second terminal 1810-2. The reference signals may be swept using different transmit beams. The reference signals may be transmitted dedicatedly for measurement by the second terminal 1910-2 or commonly transmitted for measurement of a plurality of unspecified terminals. For example, the commonly transmitted reference signals may be at least part of a discovery signal.

In step S1903, the second terminal 1910-2 transmits a measurement report including a measurement result to the first terminal 1910-1. According to an embodiment, the measurement report may include a measurement value for a transmit beam currently being transmitted. According to another embodiment, the measurement report may further include a measurement value for at least one alternative beam (e.g., a measurement value for a transmit beam having the best signal quality).

In step S1905, the first terminal 1910-1 determines an alternative beam. In other words, the first terminal 1910-1 may determine another beam to replace the transmit beam currently being transmitted. The first terminal 1910-1 may check measurement results for the reference signals included in the measurement report, and determine an alternative beam based on the checked measurement results.

In step S1907, the first terminal 1910-1 detects a beam failure. The beam failure may be detected based on the signal quality of the transmit beam in use. Even if another beam to replace the transmit beam in use is determined, if the signal quality of the transmit beam in use is sufficient, the terminal 1 1910-1 may determine that there is no beam failure situation. However, if the signal quality of the transmit beam in use is not sufficient, the first terminal 1910-1 determines that a beam failure situation has occurred. Insufficient signal quality may be determined by deterioration of signal quality over a threshold number of times.

In step S1909, the first terminal 1910-1 transmits a beam failure recovery request signal to the second terminal 1910-2. The beam failure recovery request signal explicitly or implicitly includes information on an alternative beam. According to an embodiment, the first terminal 1910-1 may transmit the beam failure recovery request signal using a resource related to the alternative beam, for example, a discovery resource in which a discovery signal is transmitted using a beam having a QCL relationship with the alternative beam. According to another embodiment, the first terminal 1910-1 may transmit the beam failure recovery request signal using a resource related to the alternative beam, for example, a discovery response resource corresponding to a discovery resource in which a discovery signal is transmitted a beam having a QCL relationship with the alternative beam.

In step S1911, the second terminal 1910-2 transmits a beam failure recovery response signal to the first terminal 1910-1. According to an embodiment, the beam failure recovery response signal may indicate whether the alternative beam is accepted. According to another embodiment, when use of the alternative beam is rejected, the beam failure recovery response signal may further include information indicating another alternative beam.

As in the embodiment described with reference to FIG. 19, the device (e.g., the first terminal 1910-1) using a transmit beam related to a beam failure may transmit a request signal triggering beam failure recovery. For example, when triggering of beam failure recovery is configured or predefined to be allowed in only one way, in other words, when the counterpart device (e.g., the second terminal 1910-2) does not allow triggering of beam failure recovery, a beam failure recovery procedure may be triggered by the first terminal 1910-1.

In the embodiment described with reference to FIG. 19, the first terminal 1910-1 detects a beam failure based on a measurement report. According to another embodiment, the first terminal 1910-1 may detect a beam failure based on feedback information indicating a decoding failure of data. Specifically, when decoding failures occur more than a threshold number of times consecutively, the first terminal 1910-1 may determine that a beam failure situation has occurred. In this case, the reference signal of step S1901 may be replaced with a data packet (e.g., a transport block, code block, or code block group), and the measurement report of step S1903 may be replaced with ACK/NACK feedback.

As described above, according to various embodiments, a beam failure recovery procedure may be performed using a millimeter wave sidelink discovery signal. In the case of unicast in millimeter wave sidelink communication, the terminal transmits a discovery signal to discover a counterpart terminal and receives a discovery response signal to the discovery signal. Using resources for these discovery-related signals, when a beam failure occurs, a beam failure recovery request may be transmitted through a discovery resource or a discovery response resource. Through this, in a beam failure situation, a beam failure recovery procedure may be performed through a resource related to discovery without configuring a separate resource.

### System and Various Devices to Which Embodiments of the Present Disclosure are Applicable

Various embodiments of the present disclosure may be combined with each other.

Hereinafter, a device to which various embodiments of the present disclosure may be applied will be described. Although not limited thereto, various descriptions, functions, procedures, proposals, methods, and/or operation flowcharts disclosed in this document may be applied to various fields requiring wireless communication/connection (e.g., 5G) between devices.

Hereinafter, it will be described in more detail with reference to the drawings. In the following drawings/description, the same reference numerals may represent the same or corresponding hardware blocks, software blocks, or functional blocks, unless otherwise indicated.

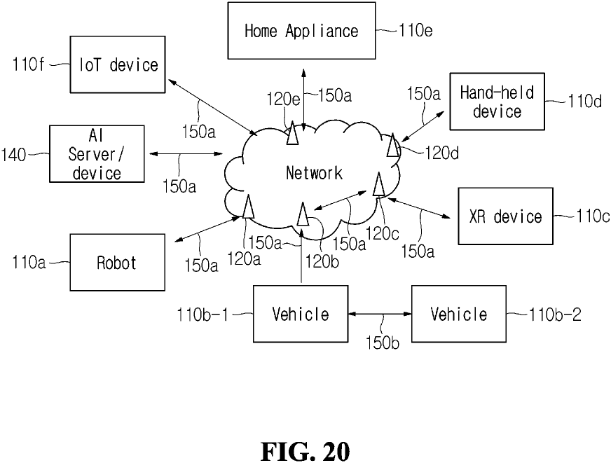

FIG. 20 illustrates a communication system, applicable to the present disclosure. The embodiment of FIG. 20 may be combined with various embodiments of the present disclosure.

Referring to FIG. 20, the communication system applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include at least one of a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100 g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120a to 120enetwork may be implemented by a wireless device, and a specific wireless device 120a may operate as a base station/network node for another wireless device.

Here, wireless communication technology implemented in wireless devices 100a to 100f of the present disclosure may include Narrowband Internet of Things for low-power communication in addition to LTE, NR, and 6G. In this case, for example, NB-IoT technology may be an example of Low Power Wide Area Network (LPWAN) technology and may be implemented as standards such as LTE Cat NB1, and/or LTE Cat NB2, and is not limited to the name described above. Additionally or alternatively, the wireless communication technology implemented in the wireless devices 100a to 100f of the present disclosure may perform communication based on LTE-M technology. In this case, as an example, the LTE-M technology may be an example of the LPWAN and may be called by various names including enhanced Machine Type Communication (eMTC), and the like. For example, the LTE-M technology may be implemented as at least any one of various standards such as 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, and is not limited to the name described above. Additionally or alternatively, the wireless communication technology implemented in the wireless devices 100a to 100f of the present disclosure may include at least one of Bluetooth, Low Power Wide Area Network (LPWAN), and ZigBee considering the low-power communication, and is not limited to the name described above. As an example, the ZigBee technology may generate personal area networks (PAN) related to small/low-power digital communication based on various standards including IEEE 802.15.4, and the like, and may be called by various names.

The wireless devices 100a to 100f may be connected to the network through the base station 120. AI technology is applicable to the wireless devices 100a to 100f, and the wireless devices 100a to 100f may be connected to the AI server 100 g through the network. The network may be configured using a 3G network, a 4G (e.g., LTE) network or a 5G (e.g., NR) network, etc. The wireless devices 100a to 100f may communicate with each other through the base stations 120a to 120e or perform direct communication (e.g., sidelink communication) without through the base stations 120a to 120e. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base stations 120a to 120e and the base stations 120a to 120e/the base stations 120a to 120e. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

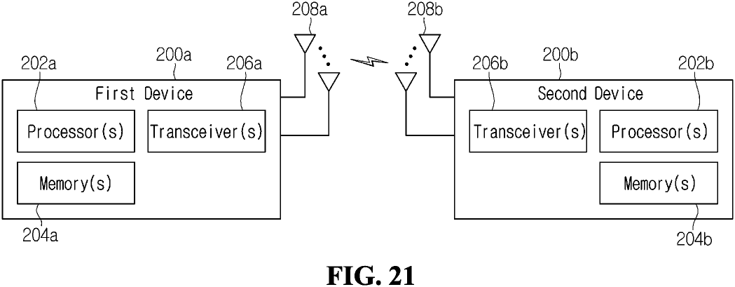

FIG. 21 illustrates wireless devices, applicable to the present disclosure. The embodiment of FIG. 21 may be combined with various embodiments of the present disclosure.

Referring to FIG. 21, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 20.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be coupled with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be coupled with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may perform wireless communications with the first wireless device 200a and may include one or more processors 202b and one or more memories 204b and may further include one or more transceivers 206b and/or one or more antennas 208b. The functions of the one or more processors 202b, one or more memories 204b, one or more transceivers 206b, and/or one or more antennas 208b are similar to those of one or more processors 202a, one or more memories 204a, one or more transceivers 206a and/or one or more antennas 208a of the first wireless device 200a.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs), one or more service data unit (SDU), messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be coupled with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be coupled with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other devices. One or more transceivers 206a and 206b may receive user data, control information, radio signals/channels, etc. described in the methods and/or operational flowcharts of the present disclosure from one or more other devices. In addition, one or more transceivers 206a and 206b may be coupled with one or more antennas 208a and 208b, and may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

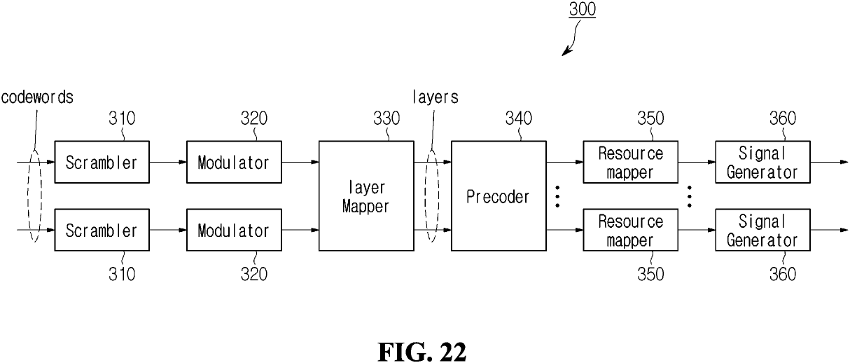

FIG. 22 illustrates a signal process circuit for a transmission signal, applicable to the present disclosure. The embodiment of FIG. 22 may be combined with various embodiments of the present disclosure.

Referring to FIG. 22, a signal processing circuit 300 may include scramblers 310, modulators 320, a layer mapper 330, a precoder 340, resource mappers 350, and signal generators 360. For example, an operation/function of FIG. 22 may be performed by the processors 202a and 202b and/or the transceivers 36 and 206 of FIG. 21. Hardware elements of FIG. 22 may be implemented by the processors 202a and 202b and/or the transceivers 36 and 206 of FIG. 21. For example, blocks 310 to 360 may be implemented by the processors 202a and 202b of FIG. 21. Alternatively, the blocks 310 to 350 may be implemented by the processors 202a and 202b of FIG. 21 and the block 360 may be implemented by the transceivers 36 and 206 of FIG. 21, and it is not limited to the above-described embodiment.

Codewords may be converted into radio signals via the signal processing circuit 300 of FIG. 22. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH). Specifically, the codewords may be converted into scrambled bit sequences by the scramblers 310. Scramble sequences used for scrambling may be generated based on an initialization value, and the initialization value may include ID information of a wireless device. The scrambled bit sequences may be modulated to modulation symbol sequences by the modulators 320. A modulation scheme may include pi/2-Binary Phase Shift Keying (pi/2-BPSK), m-Phase Shift Keying (m-PSK), and m-Quadrature Amplitude Modulation (m-QAM).

Complex modulation symbol sequences may be mapped to one or more transport layers by the layer mapper 330. Modulation symbols of each transport layer may be mapped (precoded) to corresponding antenna port(s) by the precoder 340. Outputs z of the precoder 340 may be obtained by multiplying outputs y of the layer mapper 330 by an N*M precoding matrix W. Herein, N is the number of antenna ports and M is the number of transport layers. The precoder 340 may perform precoding after performing transform precoding (e.g., DFT) for complex modulation symbols. Alternatively, the precoder 340 may perform precoding without performing transform precoding.

The resource mappers 350 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 360 may generate radio signals from the mapped modulation symbols and the generated radio signals may be transmitted to other devices through each antenna. For this purpose, the signal generators 360 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures of FIG. 22. For example, the wireless devices (e.g., 200a and 200b of FIG. 21) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

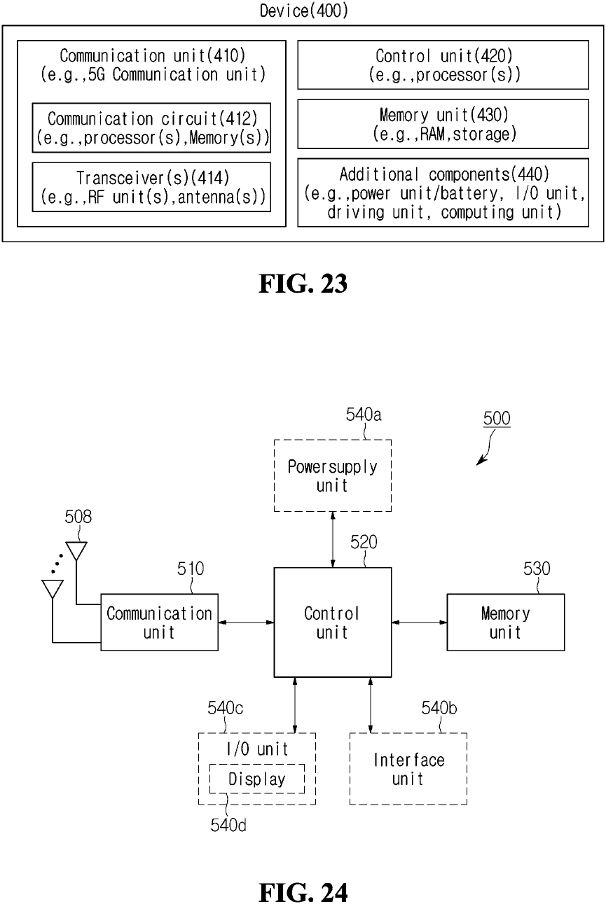

FIG. 23 illustrates a wireless device, applicable to the present disclosure. The embodiment of FIG. 23 may be combined with various embodiments of the present disclosure.

Referring to FIG. 23, a wireless device 300 may correspond to the wireless devices 200a and 200b of FIG. 21 and include various elements, components, units/portions and/or modules. For example, the wireless device 300 may include a communication unit 310, a control unit (controller) 320, a memory unit (memory) 330 and additional components 340.

The communication unit 410 may include a communication circuit 412 and a transceiver(s) 414. The communication unit 410 may transmit and receive signals (e.g., data, control signals, etc.) to and from other wireless devices or base stations. For example, the communication circuit 412 may include one or more processors 202a and 202b and/or one or more memories 204a and 204b of FIG. 21. For example, the transceiver(s) 414 may include one or more transceivers 206a and 206b and/or one or more antennas 208a and 208b of FIG. 42.

The control unit 420 may be composed of at least one processor set. For example, the control unit 420 may be composed of a set of a communication control processor, an application processor, an electronic control unit (ECU), a graphic processing processor, a memory control processor, etc. The control unit 420 may be electrically coupled with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The memory unit 430 may be composed of a random access memory (RAM), a dynamic RAM (DRAM), a read only memory (ROM), a flash memory, a volatile memory, a non-volatile memory and/or a combination thereof. The memory unit 430 may store data/parameters/programs/codes/commands necessary to derive the wireless device 400. In addition, the memory unit 430 may store input/output data/information, etc.

The additional components 440 may be variously configured according to the types of the wireless devices. For example, the additional components 440 may include at least one of a power unit/battery, an input/output unit, a driving unit or a computing unit. Without being limited thereto, the wireless device 400 may be implemented in the form of the robot (FIG. 41, 100a), the vehicles (FIG. 41, 100b-1 and 100b-2), the XR device (FIG. 41, 100c), the hand-held device (FIG. 41, 100d), the home appliance (FIG. 41, 100e), the IoT device (FIG. 41, 100f), a digital broadcast terminal, a hologram device, a public safety device, an MTC device, a medical device, a Fintech device (financial device), a security device, a climate/environment device, an AI server/device (FIG. 41, 140), the base station (FIG. 41, 120), a network node, etc. The wireless device may be movable or may be used at a fixed place according to use example/service.

FIG. 24 illustrates a hand-held device, applicable to the present disclosure. FIG. 24 exemplifies a hand-held device applicable to the present disclosure. The hand-held device may include a smartphone, a smart pad, a wearable device (e.g., a smart watch or smart glasses), and a hand-held computer (e.g., a laptop, etc.). The embodiment of FIG. 24 may be combined with various embodiments of the present disclosure.

Referring to FIG. 24, the hand-held device 500 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/440ato 540c may correspond to the blocks 310 to 330/340 of FIG. 23, respectively, and duplicate descriptions are omitted.

The communication unit 510 may transmit and receive signals and the control unit 520 may control the hand-held device 500, and the memory unit 530 may store data and so on. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

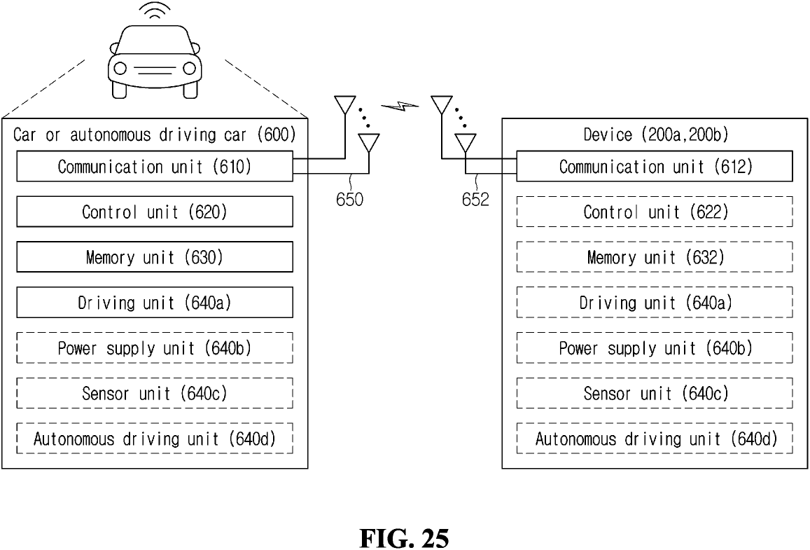

FIG. 25 illustrates a car or an autonomous vehicle, applicable to the present disclosure. FIG. 25 exemplifies a car or an autonomous driving vehicle applicable to the present disclosure. The car or the autonomous driving car may be implemented as a mobile robot, a vehicle, a train, a manned/unmanned aerial vehicle (AV), a ship, etc. and the type of the car is not limited. The embodiment of FIG. 25 may be combined with various embodiments of the present disclosure

Referring to FIG. 25, the car or autonomous driving car 600 may include an antenna unit (antenna) 608, a communication unit (transceiver) 610, a control unit (controller) 620, a driving unit 640a, a power supply unit (power supply) 640b, a sensor unit 640c, and an autonomous driving unit 640d. The antenna unit 650 may be configured as part of the communication unit 610. The blocks 610/630/640a to 640d correspond to the blocks 510/530/540 of FIG. 24, and duplicate descriptions are omitted.

The communication unit 610 may transmit and receive signals (e.g., data, control signals, etc.) to and from external devices such as another vehicle, a base station (e.g., a base station, a road side unit, etc.), and a server. The control unit 620 may control the elements of the car or autonomous driving car 600 to perform various operations. The control unit 620 may include an electronic control unit (ECU). The driving unit 640a may drive the car or autonomous driving car 600 on the ground. The driving unit 640a may include an engine, a motor, a power train, wheels, a brake, a steering device, etc. The power supply unit 640b may supply power to the car or autonomous driving car 600, and include a wired/wireless charging circuit, a battery, etc. The sensor unit 640c may obtain a vehicle state, surrounding environment information, user information, etc. The sensor unit 640c may include an inertial navigation unit (IMU) sensor, a collision sensor, a wheel sensor, a speed sensor, an inclination sensor, a weight sensor, a heading sensor, a position module, a vehicle forward/reverse sensor, a battery sensor, a fuel sensor, a tire sensor, a steering sensor, a temperature sensor, a humidity sensor, an ultrasonic sensor, an illumination sensor, a brake pedal position sensor, and so on. The autonomous driving sensor 640d may implement technology for maintaining a driving lane, technology for automatically controlling a speed such as adaptive cruise control, technology for automatically driving the car along a predetermined route, technology for automatically setting a route when a destination is set and driving the car, etc.

For example, the communication unit 610 may receive map data, traffic information data, etc. from an external server. The autonomous driving unit 640d may generate an autonomous driving route and a driving plan based on the acquired data. The control unit 620 may control the driving unit 640a (e.g., speed/direction control) such that the car or autonomous driving car 600 moves along the autonomous driving route according to the driving plane. During autonomous driving, the communication unit 610 may aperiodically/periodically acquire latest traffic information data from an external server and acquire surrounding traffic information data from neighboring cars. In addition, during autonomous driving, the sensor unit 640c may acquire a vehicle state and surrounding environment information. The autonomous driving unit 640d may update the autonomous driving route and the driving plan based on newly acquired data/information. The communication unit 610 may transmit information such as a vehicle location, an autonomous driving route, a driving plan, etc. to the external server. The external server may predict traffic information data using AI technology or the like based on the information collected from the cars or autonomous driving cars and provide the predicted traffic information data to the cars or autonomous driving cars.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3^{rd} generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method of operating a user equipment (UE) in a wireless communication system, the method comprising:
performing communication with a device using a first beam;
detecting a beam failure of the first beam;
transmitting a request signal including information related to a second beam to replace the first beam;
receiving a response signal corresponding to the request signal from the device; and
performing communication with the device using the second beam,
wherein the request signal is transmitted through a resource associated with the second beam among resources related to discovery operation between the terminal and the device.

2. The method of claim 1, wherein the request signal is expressed by at least one field included in a discovery response signal or comprises a signal in a format different from that of the discovery response signal.

3. The method of claim 1, wherein the resource associated with the second beam comprises a discovery response resource corresponding to a discovery resource in which a discovery signal is transmitted using a beam having a quasi co-located (QCL) relationship with the second beam.

4. The method of claim 1, wherein the resource associated with the second beam comprises a discovery resource in which a discovery signal is transmitted using a beam having a quasi co-located (QCL) relationship with the second beam.

5. The method of claim 1, further comprising:
detecting the beam failure based on measurement of a signal transmitted from the device.

6. The method of claim 1, further comprising:
receiving, from the device, a measurement report including a measurement result of a signal transmitted from the UE, and
detecting the beam failure based on the measurement report.

7. The method of claim 1, further comprising:
detecting the beam failure based on a decoding failure of the data transmitted from the device.

8. The method of claim 1, further comprising:
detecting the beam failure based on acknowledge (ACK)/negative-ACK (NACK) feedback for data transmitted to the device.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A user equipment (UE) in a wireless communication system, comprising:
a transceiver; and
a processor coupled to the transceiver and configured to:
perform communication with a device using a first beam;
detect a beam failure of the first beam;
transmit a request signal including information related to a second beam to replace the first beam;
receive a response signal corresponding to the request signal from the device; and
perform communication with the device using the second beam,
wherein the request signal is transmitted through a resource associated with the second beam among resources related to discovery operation between the terminal and the device.

21. The UE of claim 20, wherein the request signal is expressed by at least one field included in a discovery response signal or comprises a signal in a format different from that of the discovery response signal.

22. The UE of claim 20, wherein the resource associated with the second beam comprises a discovery response resource corresponding to a discovery resource in which a discovery signal is transmitted using a beam having a quasi co-located (QCL) relationship with the second beam.

23. The UE of claim 20, wherein the resource associated with the second beam comprises a discovery resource in which a discovery signal is transmitted using a beam having a quasi co-located (QCL) relationship with the second beam.

24. The UE of claim 20, further comprising:
detecting the beam failure based on measurement of a signal transmitted from the device.

25. The UE of claim 20, further comprising:
receiving, from the device, a measurement report including a measurement result of a signal transmitted from the UE, and
detecting the beam failure based on the measurement report.

26. The UE of claim 20, wherein the processor is further configured to:
detect the beam failure based on a decoding failure of the data transmitted from the device.

27. The UE of claim 20, wherein the processor is further configured to:
detect the beam failure based on acknowledge (ACK)/negative-ACK (NACK) feedback for data transmitted to the device.

28. A user equipment (UE) in a wireless communication system, comprising:
a transceiver; and
a processor coupled to the transceiver and configured to:
perform communication with a device using a first beam;
receive, from a device, a request signal including information related to a second beam to replace the first beam based on a beam failure of the first beam being detected;
transmit, to the device, a response signal corresponding to the request signal; and
performing communication with the device using the second beam,
wherein the request signal is transmitted through a resource associated with the second beam among resources related to discovery between the UE and the device.

29. The UE of claim 28, wherein the processor is further configured to:
transmit, to the device, a measurement report including a measurement result of a signal transmitted from the device.

30. The UE of claim 28, wherein the processor is further configured to:
transmit, to the device, acknowledge (ACK)/negative-ACK (NACK) feedback for data received from the device.

31. The UE of claim 28, wherein the processor is further configured to:
identify the second beam by identifying a transmit beam corresponding to a receive beam used in a discovery response resource carrying the request signal.
